(19) United States
(12) Patent Application Publication
(10) Pub. No.: US 2012/0145783 A1
(43) Pub. Date: Jun. 14, 2012

(54) POWERED AUTHENTICATING CARDS

(75) Inventor: Steven LANDAU, Lakeland, FL (US)

(73) Assignee: SOLICORE, INC., Lakeland, FL (US)

(21) Appl. No.: 13/397,816

(22) Filed: Feb. 16, 2012

Related U.S. Application Data
(63) Continuation of application No. 11/930,903, filed on Oct. 31, 2007.
(60) Provisional application No. 60/855,395, filed on Oct. 31, 2006.
(60) Provisional application No. 60/855,392, filed on Oct. 31, 2006.

(51) Int. Cl. G06F 21/00; G06K 5/00

(52) U.S. Cl. 235/382

(57) ABSTRACT

The present invention provides systems and methods for powered video game playing cards, powered voter authentication cards, powered financial transaction cards, and methods for administering the use of each. The cards generally include a thin, flexible substrate and a battery disposed within the substrate. A dynamic token value generator and/or biometric sensor is disposed within the substrate and is powered by the battery. An electronic display is mounted on the substrate for displaying a token value generated by the dynamic token value generator. The token value is configured to be used in conjunction with a back-end token value secure identification system to provide access to secure electronic information or capabilities.

This application claims the benefit of U.S. Provisional Application Nos. 60/855,395, filed Oct. 31, 2006; and 60/855,392, filed Oct. 31, 2006, which are herein incorporated by reference in their entirety.

### BACKGROUND

1. Field of the Invention

The present invention relates generally to authenticating cards and, more particularly, to dynamic, powered authenticating cards that provide access to electronic information, and/or enable authenticated voting and financial transaction.

2. Background of the Invention

The popularity of computer and video games (collectively referred to herein as “video games”) has been steadily increasing since the late 1980s. The video game market includes video console games (e.g., Sony Playstation™, Microsoft Xbox™ and Nintendo Wii™), personal computer (PC) games, and online computer games. In any of these formats, a typical game provides multimedia entertainment, including three-dimensional graphics, sound effects, music, storytelling, and interactivity. The interactive features capture the interest of the player and encourage the player to explore the different environments, story lines, and objectives or challenges of a video game.

To enhance gameplay and encourage a player to continue playing, video game designers often structure games with different levels, each of which must be completed in order to advance to the next level. As the player completes the required tasks, the game can unlock new levels, “worlds,” and features, making them available to the player. Designers also embed secret features into games, which can only be accessed by performing a sequence of operations within the game or by entering a code, sometimes referred to as a “cheat code.”

In the case of an online game, the publisher of a game can host and control access to a virtual online world. Typically, the publisher requires a player to register with the game and then requires some type of authentication to log onto and play the game.

Voting methods encounter similar authentication challenges. One of the problems with current voting methods is fraud, including, among other things, individuals who vote multiple times when not authorized to do so, individuals who vote in the place of other individuals (without appropriate authorization), and the general lack of a voting/voter audit trail for subsequent analysis.

It would be desirable to have a system that alleviates doubts in the quality of a given voting system or method, and addresses the deficiencies of known voting systems.

Financial transactions encounter similar authentication challenges. One of the problems with current financial transactions is fraud, including, among other things, individuals who steal identities or use a scheme called “phishing” to gain personal information to commit financial fraud. Identity theft (fraud committed by individuals who steal other individuals identity), is extremely destructive to the individuals affected and is generally difficult to stop once an individual's financial identity has been compromised.

It would be desirable to have a system that authenticates individuals prior to executing financial transactions, limits personal information from being exposed, works with current transactional systems to reduce implementation issues, and addresses system deficiencies and limitations.

### SUMMARY OF THE INVENTION

In accordance with an embodiment of the present invention, a powered video game playing card is provided that comprises a thin, flexible substrate and a battery disposed within the substrate. A dynamic token value generator is disposed within the substrate and is powered by the battery. An electronic display is mounted on the substrate for displaying a token value generated by the dynamic token value generator. The token value is configured to be used in conjunction with a back-end token value secure identification system to provide access to a locked portion of a video game.

In accordance with another embodiment of the present invention, a powered voting card is provided that comprises a thin, flexible substrate and a battery disposed within the substrate. A dynamic token value generator is disposed within the substrate and is powered by the battery. An electronic display is mounted on the substrate for displaying a token value generated by the dynamic token value generator. The token value is configured to be used in conjunction with a back-end token value secure identification system to authenticate a voter.

In accordance with another embodiment of the present invention, a method of providing access to electronic information is provided that comprises distributing a plurality of cards, each card having a thin and generally flexible form and having a dynamic token value generator mounted therein. Through a network, a token value generated by a dynamic token value generator in one of the plurality of cards is received, the token value being inputted by a user. The received token value is authenticated by means of a back-end token value secure identification system and access is provided to previously inaccessible electronic information.

In accordance with another embodiment of the present invention, a method of administering a vote is provided that comprises distributing a plurality of voting cards to voters, each voting card having a thin and generally flexible form and having a dynamic token value generator mounted therein. A static identifier is associated with voters that receive a voting card. A particular voter is authenticated by receiving an input denoting an identification of the particular voter and receiving an input corresponding to a static identifier. The particular voter is firstly authenticated by validating that the static identifier is associated with the particular voter. An input is then received that corresponds to a biometric fingerprint scan or an instantaneous token value displayed on the voting card received by the particular voter and the particular voter is secondly authenticated by validating the fingerprint scan or the instantaneous token value by means of a back-end secure identification system. If the particular voter has been firstly and secondly authenticated, the particular voter is allowed to proceed to cast a vote.

In accordance with another embodiment of the present invention, a method of administering a vote is provided that comprises distributing a plurality of voting cards to voters, each voting card having a thin and generally flexible form and having a dynamic token value generator mounted therein. A static identifier is associated with each voting card in a back-end system and is provided and distributed along with its associated voting card. A particular voter card is authenticated by receiving an input corresponding to a static identifier and receiving an input corresponding to a biometric fingerprint scan or an instantaneous token value displayed on the particular voting card. The particular voter card is authenticated by validating the fingerprint scan or the instantaneous token value by means of a back-end secure identification system based on the input corresponding to a static identifier. If the particular voter card has been authenticated, the voter is allowed to proceed to cast a vote.

### BRIEF DESCRIPTION OF THE DRAWINGS

FIG. 1 is a schematic diagram of a powered game playing card according to an embodiment of the present invention.

FIG. 2A is a schematic diagram of a powered authenticating election voting card according to an embodiment of the present invention.

FIG. 2B is a schematic diagram of a powered authenticating financial access card according to an embodiment of the present invention.

FIG. 3 is a schematic diagram of a powered authenticating voting card according to another embodiment of the present invention.

### DETAILED DESCRIPTION OF THE INVENTION

The present invention provides dynamic, powered authenticating cards, which can provide access to restricted electronic information and/or systems. One embodiment of the present invention provides a powered authenticating game playing card, which provides access to, for example, a video game. Another embodiment provides a powered authenticating voting card, which provides access to a restricted voting system. Yet another embodiment provides a powered authenticating financial access card, which provides access to a restricted financial information system.

With regard to all embodiments of the present invention, including the powered game playing cards, authenticating voting cards, and authenticating financial access cards (collectively referred to herein as “authenticating cards”), the electrical circuitry embedded in a card can be activated by any means suitable for a particular application. For example, the circuitry can be activated by light sensors, audio sensors, motion sensors, pressure sensors, wireless sensors, biometric sensors, or mechanical switches. With light, audio, and motion, the authenticating card would be activated when the appropriate stimulus is received. With wireless sensors using, for example, radio frequency identification (RFID), Bluetooth™, Ultra Wide Band (UWB), WiFi, or Near Field Communication (NFC) technology, the authenticating card would be activated by the appropriate wireless signal. With mechanical switches, the authenticating card can be, for example, activated by a user's pressing a button or multiple buttons, or by a sliding a switch. With a biometric sensor, the authenticating card can be, for example, activated by a user's fingerprints by placing or sliding the authenticating user's registered fingerprint on or across a biometric sensor. In some embodiments, a user-actuated mechanical switch in conjunction with a biometric sensor may be preferred to save power and extend the shelf life of the authenticating card.

To provide authentication, the present invention can use a token value that changes with time, as described above. In an embodiment, the present invention displays the token value on the display of a smartcard-like device. The token value can change after a relatively small period (e.g., every 30-60 seconds). When combined with an optional static identification value (e.g., a card number or Personal Identification Number (PIN) obtained via a registration process), the token value provides a unique identification for a user, and a secure method by which the user can access electronic data or an electronic system, such as a video game or a feature of a video game.

An example of a suitable technology that supports such token values is produced by RSA™, the security division of EMC² of Bedford, Mass. As described at RSA's website, to access resources protected by a token value secure identification system, such as the RSA SecurID system, users may combine a secret PIN (something they alone know) or biometric authentication with token codes generated by an dynamic token value generator or authenticator (something they physically possess). The result is a unique, one-time-use passcode that is used to positively identify, or authenticate, the user. If the code is validated by the back-end token value secure identification system, the user is granted access to the protected resource. If it is not recognized, the user is denied access.

With token value hardware authenticators such as the RSA SecurID, no interaction with a user desktop computer is required—that is, a user (e.g., a voter, video game player, or financial transaction) does not have to install or maintain any software. Equally important, the user is not required to program tokens. In addition, no user maintenance is required. As a result, this type of authentication solution is easy to deploy, administer, and use.

In an embodiment of the present invention, the circuitry and battery of a dynamic token value hardware authenticator is capable of insertion into a substrate equal in size to a conventional credit card or playing card, and meets at least the flexibility requirements of ISO 7816. An appropriate flexible type battery for such an apparatus is available from Solicore (Lakeland, Fla.), which produces batteries using polymer matrix electrolyte (PME). The batteries are ultra-thin, flexible, environmentally friendly, and safe, and preferably having the following characteristics:
low profile design—approximately 0.3 mm thick;
flexible and will not break or crack when bent or flexed;
conformable, in that the electrolyte can be a solid, non-compressible film, which can be shaped and formed into a variety of designs;
compatible with high speed printing and binding processes, and card manufacturing processes, and can survive hot lamination processes;
operable over a wide temperature range (−20° C. to +60° C.);
offer high ionic conductivity over a broad temperature range;
feature low self discharge rates (less than 1% per month);
provide high energy density (up to 300 WW/l), thus offering maximum performance in smallest packages;
possess self connecting terminals;
are non-toxic, disposable, and environmentally friendly;
contain solid polymer electrolyte—no volatile liquids or gelling agents;
offer overall safety: with no out-gassing, swelling, or thermal runaway;

no need for added safety devices; and pass UL requirements for crush test, drop test, and nail test; and
enjoy an inherently safe design, which reduces the need for additional battery safety circuitry.

In another embodiment, the battery is not necessarily flexible. For example, the battery can be a small, thin coin cell battery inserted into a flexible or semi-rigid substrate. The coin cell battery can be suitably small such that it does not appreciably affect the overall flexibility of the substrate and the card. Such coin cell types are available as the WaferThin™ coin cell, from Micron Communications and the CR2004 or CR2404 model batteries from Panasonic.

### Exemplary Powered Game Playing or Financial Information Access Cards

An embodiment of the present invention provides a powered game playing card that provides authentication to control access to a video game or features of a video game. The playing card comprises a thin, flexible substrate (e.g., paper, thin cardboard stock, or plastic) having an embedded battery and electrical circuitry. The playing card is preferably equal in size to a conventional credit card or playing card, and may meet at least the flexibility requirements of ISO 7816. Powered by the battery, the circuitry can activate electronic output devices that, for example, display an encrypted light array, display alphanumeric characters or graphics, or play a voice message. From this output, a player can obtain information necessary to authenticate access to a video game or features of a video game. For example, the output can comprise the use of a dynamic token value, i.e., a value that changes with time. The playing card can be branded or printed and may be traded, collected, or distributed as part of a promotion.

In addition to the token value hardware authenticator, the circuitry of a game playing card includes at least one electronic output device that provides the user with the information necessary for authentication. For example, the electronic output device can display an encrypted light array, alphanumeric characters, or a graphic, or can play a voice message. The user would then use the information for the purpose of authentication to obtain access to a video game or feature of a video game. For example, the electronic output device could provide a code that the user would enter into a video game to unlock a new level of play, a new environment, or a new character feature (e.g., use of a new weapon in a fighting game).

In a similar fashion, a powered card is provided that includes the structural elements as described above with respect to the game playing card but is instead used to provide access to financial information or transactions over an electronic network. As one of skill in the art will appreciate, the elements described herein that are relevant to both embodiments are substantially similar and therefore they will be discussed together. It will also be understood that references to “players,” “game playing cards,” or the like are equally applicable to corresponding participants in the financial information/transaction embodiments of the invention. One of skill in the art will further appreciate that the powered cards may be relevant to any similar activity in which the user of a card is to be authenticated before access to electronic information or transactions is granted.

In one possible implementation, the powered game playing card or financial transaction card is branded (e.g., with graphics, logos, colors, or holography) to associate the card with the video game or financial institution to which it provides access. The powered game playing cards or financial transaction cards may be disposable (in that they may have limited temporal use) or may be intended to be collectors' items.

The powered cards in accordance with the present invention may be given away free, given away as part of a related promotion, given as a gift with a purchase of an unrelated item, included in the packaging of a video game, or made available for purchase on their own as products in their own right.

As mentioned above, it may be desirable for the user to employ a PIN in conjunction with the token value to generate a one time passcode. One way to obtain such a PIN is by including the same on the powered card itself, by mailing the pin under separate cover to the user, or, perhaps more preferably, by enabling an on-line pre-registration procedure to identify individual players and allow players to select their own PIN. Registration adds a level of authentication (namely, that there is more certainty that the person who registered is also the person who accesses the video game). The integrity of a log-in to a website using a static password can be further secured by presenting a challenge on the website that has to be keyed in to the token generating card using a 10-key pad, or transmitted to the card via a card interface, or via RFID, NFC, Bluetooth, or UWB.

In one aspect of the invention, to ensure that a player accesses a game for only a predetermined number of times, a tallying agent can monitor the number of times the player accesses the game and once the predetermined number is reached, can block the player from further access. Thus, for example, a playing card could limit a player's access to only one additional environment in a video game.

The use of a powered game playing card in accordance with the invention may be by telephone where the player enters the token value via the dial pad, for example, to gain access to a feature of an online video game. The token value-supplying powered card may also be suitable for use with mobile phone-supported applications such as the short message service (SMS). Of course, the token value may also be entered within the video game itself.

Because the form factor of the present invention is that of a credit card or playing card, it is more conducive to being marketed through multiple and potentially disparate distribution channels. For instance, the powered game playing card may be given away for free at stores, trade shows, or on the street, may be branded or co-branded, may be sent via mail order, and may be associated with clothing, food, or Internet applications, among other things. Because the card itself may be produced using well-known card manufacturing techniques, the card's graphics can be easily changed to suit the particular video game genre, target market, or seasonal theme.

Those skilled in the art will appreciate that the powered game playing card of the present invention is quite different from a single use, static ID card. For instance, with a static ID card, it is not possible to authenticate that the actual holder of the static ID card is accessing the game, meaning that someone could copy the static number of the card and attempt to access the game. The real “owner” of the card could then also attempt to access that game, and a tallying mechanism/server would not be able to tell which access attempt was from the authentic user. Even if pre-registration occurred with a static ID card, or “scratch card” number, one's request for access could not be authenticated or validated unless the tallying mechanism/server managed to capture, for example, an IP address associated with a computer from which pre-registration was performed. Of course, if authentication/validation were based on a computer's IP address, one could not play from, for example, a library or a friend's house, as the IP address (which would be the basis for authentication/validation) would almost certainly be different from the IP address stored at the time of pre-registration.

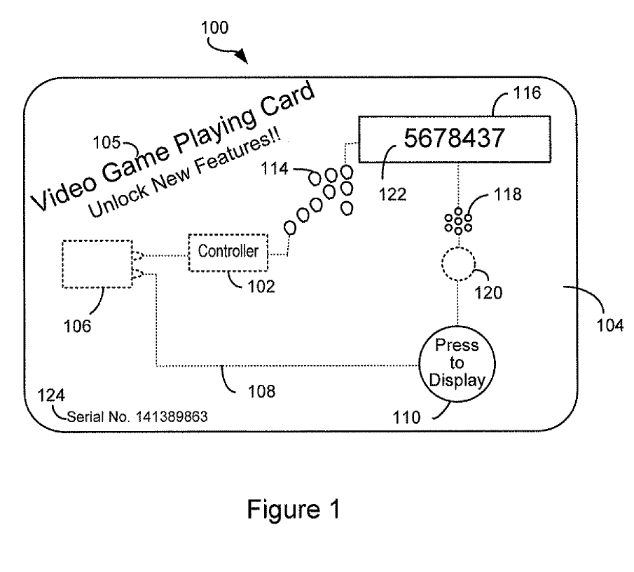

FIG. 1 illustrates a powered game playing card 100 according to an embodiment of the present invention. As shown, game playing card 100 comprises a substrate 104, a battery 106, and circuitry 108. Substrate 104 can be paper or any other thin flexible material, on which are preferably printed copy and/or graphics 105 associated with the video game and instructions for using the powered print game playing card 100. Battery 106 and circuitry 108 are embedded in substrate 104 (e.g., sandwiched between a front and back face of substrate 104), as represented by the dashed lines. Circuitry 108 includes a controller 102, which may include, for example, a token value generator, a biometric sensor, a microprocessor, memory, clock, and any other necessary circuitry or devices. Circuitry 108 is controlled by a switch 110, such as a press button. Alternatively, circuitry 108 could be controlled by a light, audio, motion sensor or pressure sensor. Circuitry 108 also includes one or more electronic output devices that are activated when circuitry 108 is powered. For example, circuitry 108 can include an illumination device 114, a display 116, a speaker 118, and/or a vibrator 120.

As one skilled in the art would appreciate, circuitry 108 is shown only for illustration purposes and could include differently configured wires or conductive traces. For example, conductors to the illumination device 114 could be individually connected to each of the illumination elements (e.g., each LED or each electroluminescent device), or connected collectively such that the elements could be illuminated in unison, or some combination thereof. Similarly, if an alphanumeric or graphic display is used, the circuitry can be configured to drive the individual elements thereof in accordance with any desired sequence or design.

In one embodiment, substrate 104 comprises front and back faces made from cardstock and adhered together using adhesive. Battery 106, circuitry 108, and the other components are all sufficiently thin and flexible that the powered game playing card has the same “feel” as a conventional cardstock playing card.

In another embodiment, substrate 104 comprises front and back faces made from plastic sheeting, similar to that used for a credit card-sized ISO 7816 compliant card. Optionally, thinner layers of plastics can be used to allow for increased flexibility.

In operation, powered print game playing card 100 activates in response to completion of circuitry 108, which provides or enables the provision of power from battery 106 to the electronic output devices. In this example, circuitry 108 is completed by pressing button 110. Alternatively, with a sensor, the game playing card 100 could automatically activate, in response to light (e.g., from removing the game playing card 100 from its packaging), to sound (e.g., an audible command from the consumer), to a wireless signal (e.g., from an RFID or NFC reader or emitter), or to motion (e.g., from the movement of game playing card 100).

Once circuitry 108 is closed, controller 102 and circuitry 108 activate one or more electronic output devices 114, 116, 118, and 120. For example, controller 102 and circuitry 108 can light illumination device 114 in a particular pattern that reveals a code, can display an alphanumeric message or graphic on display 116, can play a sound, a message, or music through speaker 118 (e.g., a tune associated with the video game or a voice stating a code), or can activate vibrator 120 in a pattern that reveals a code. Illumination device 114 can comprise, for example, LED lights, incandescent lights, or electroluminescent devices. Display 116 can comprise, for example, an LCD screen, an electroluminescent display (such as those produced by Philips Electronics of Amsterdam; Sharp of Osaka, Japan; or Planar Systems, Inc. of Beaverton, Oreg.), or a printable electronic ink (such as those produced by E Ink of Cambridge, Mass., or Xerox of Palo Alto, Calif.). Speaker 118 can comprise, for example, a miniature speaker suitable for tight form factor applications. Vibrator 120 can comprise, for example, a miniature vibrator suitable for tight form factor applications, such as applications involving pagers and cellular telephones.

In an embodiment of the invention, display 116 is used to disclose a token value 122 to the game player, which is generated by a token value generator of controller 102. Alternatively, or in addition to display 116, the token value can be announced through speaker 118, which could be especially useful for vision-impaired users. In addition to providing the token value, the present invention can enhance the aesthetic value of game playing card 100 through additional visual, audible, and tactile stimuli, using electronic output devices 114, 116, 118, and 120.

In one aspect of the present invention, game playing card 100 provides a player with access to a feature of an online video game, such as a secure area of the game or a new capability for the player's game character. The playing card 100 discloses a token value that the player provides while logging onto or playing the online game. The token is associated with the particular player through a pre-registration process (e.g., using a static identification value, such as a PIN) as discussed above, or by associating an identification number (e.g., a serial number 124 printed on the card, as shown in FIG. 1) with the playing card 100 and associating the user (e.g., either anonymously or with the user's actual name) with the card identification number the first time the player uses the card. The back-end token value secure identification system establishes these associations, before which the card can be deactivated.

In addition, after the player enters the token value provided by the game playing card 100, the back-end token value secure identification system validates the token value, determines whether access should be granted, and if so, tallies the event to keep track of the conditions under which the token can be used (e.g., a certain number of times or during a certain time period). Thus, for example, if the game playing card 100 is intended for the one-time use of a “cheat code,” the back-end token value secure identification system validates entry of the correct token value, grants the player access to the cheat feature, and deactivates the card so that any further token values received from that card are denied access. In the case of a game playing card 100 that provides access to a feature multiple times or to multiple features, the back-end token value secure identification system would tally each event and decrement the remaining available access events or the remaining available features. In the case of game playing card 100 that provides access based on a time period, the back-end token value secure identification system would determine whether time remains (e.g., whether a three month subscription has expired).

One type of online computer role-playing game to which this aspect of the invention applies is a massively-multiplayer online role-playing game (MMORPG), in which a large number of players interact with one another in a virtual world. As in all role playing games, players assume the role of a fictional character and take control over many of that character's actions. Thus, in one embodiment of the invention, game playing cards are widely distributed among the players, with each card associated with a particular player. In receiving the token values from the many different players, the back-end token value secure identification system controls and monitors access by each of the players to the features of the games, granting and blocking access according to the rules (e.g., unlock three new character capabilities or unlock an unlimited number of capabilities during a subscription period) established for each card (which are also preferably printed on the card to inform a player accordingly).

In another aspect of the present invention, game playing card 100 provides a player with access to an access code (e.g., cheat code) that is preprogrammed in a video console game or PC game. The game playing card 100 displays a token value, which the player provides to the back-end token value secure identification system, for example, by logging onto a website, entering a code into a video game console, or calling a call center (e.g., having an interactive voice response system). As further examples, the token value can be entered into a network terminal or internet appliance, including cellular telephones, PDAs, and computers. The game playing card 100 is then associated with the player using any of the means described above, such as pre-registration with a static identification value. If the token value and any other required identification are correct, the player is provided with the access code, which the player then separately enters in the video console game or PC game to gain access to the new feature. As with an online game, the back-end token value secure identification system can tally the event to deny access if a player tries to use the card again.

In another aspect of the present invention, game playing card 100 provides a user, such as a fantasy sports player, with access to special features on a website. For example, multiple playing cards could be distributed to fans and fantasy sports players at sporting events and sports trade shows. These users could then use the cards to gain access to sports highlights on the website, for example, viewing video highlights of the scoring plays of their fantasy team players. As described above, the cards could securely control the users' access to the features, for example, providing only a certain number of video highlights per week.

In another aspect of the present invention, game playing card 100 controls access by a user to video productions, such as televisions shows, movie trailers, or full length movies, which could, for example, be co-branded with a video game. In this aspect, users could pre- register with an Internet video service provider. The video service provider would then distribute cards to the users and control their access to the video content as described above. In a further aspect, the cards are associated with a particular video content, such as a particular movie, and could have information about the video content and graphics from the video content printed on the card itself. The cards could provide a user with one-time secured access to the video content. In this manner, an Internet video service provider could control access to its video content and bandwidth. In one implementation, instead of distributing actual video content on recordable media (as Netflix™ does in distributing DVDs), a video content provider can distribute cards 100, and use them to securely control access to the content over the Internet. In addition, the cards could be disposable, eliminating the need for the user to return anything to the video content provider.

### Exemplary Powered Voting Cards

In accordance with a further embodiment of the present invention, a system is provided whereby a single vote may be individually recorded, authenticated, and subsequently audited, as may be desired. The voting system, like the powered game playing cards described above, can be based primarily on the use of a dynamic token value. In a preferred embodiment, the token value is displayed on a smart card-like device that includes a display that presents to a user (i.e., a voter) a token value that changes after a relatively small period of time (e.g., every 30-60 seconds). When combined with an optional static identification value, e.g., a card number, a biometric finger print scan, or PIN obtained via a registration process, any vote that is associated therewith becomes unique to the voter, and relatively simple to audit.

As one electronic voting specialist has proclaimed, there are six commandments that are typically associated with voting:

1. Thou shalt keep each voter's choices an inviolable secret.
2. Thou shalt allow each eligible voter to vote only once, and only for those offices for which she is authorized to cast a vote.
3. Thou shalt not permit tampering with thy voting system, nor the exchange of gold for votes.
4. Thou shalt report all votes accurately.
5. Thy voting system shall remain operable throughout each election.
6. Thou shalt keep an audit trail to detect sins against Commandments II-IV, but thy audit trail shall not violate Commandment I.

### (M. Shamos '93.)

In the same vein, others have noted several desirable requirements for voting systems:

1. Only registered voters may vote.
2. Each voter may vote only once, unless otherwise permitted.
3. Ballot secrecy (privacy).
4. Universal verifiability of election result.

### 5. Robustness.

6. No interaction between voters.
7. No vote duplication (copying someone's encrypted vote without knowing the vote), or other means of influence (intermediate election results).
8. No coercion, vote-selling.

With these desired voting rules in mind, an embodiment of the present invention use a token generating card in voting applications. Similar to the game playing card described above, a voting card may display an encrypted light array, or numeric or graphical display arrangement that is used for the purpose of authentication to a secure site to allow for, in this case, an authenticated vote for a poll (e.g., for CNN), game show, reality show (e.g., American Idol™), sweepstakes, etc. to authenticate that the vote itself is real and authentic. If the powered voting card is securely associated with an individual anonymously or expressly (i.e., via a pre-registration process), then the vote can be authenticated to the individual for such applications including governmental voting, etc.

In an embodiment, the powered voting card is branded with graphics, logos, color, holography, etc. that is associated for a particular vote use (e.g., voting for a specific American Idol™ season or party affiliation). Similarly, powered voting cards may be employed for specific polls (e.g., presidential favorability ratings), or elections (e.g., the 2006 mid-term elections). In this way, powered cards may be disposable (in that they may have limited temporal use) and/or may instead become collectors' items.

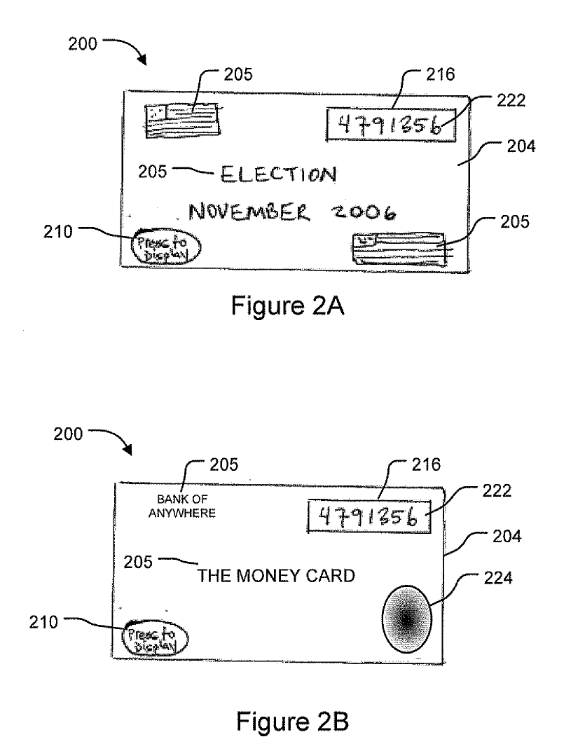

With reference to FIGS. 2A and 2B, a powered card 200 is shown that may be used, for example, in political elections or in financial transactions. A substrate 204 made of thin, flexible plastic, cardboard stock, paper, or other material is provided and may have graphical indicia 205 printed thereon for identification and/or aesthetic purposes. In the embodiment shown in FIG. 2A, for example, the indicia 205 indicates that the card is used for voting in the November 2006 elections, and has depictions of the American flag for aesthetic purposes. In FIG. 2B, indicia 205 indicate the issuer of the card and that it is intended for financial transactions.

To use the card 200, a user may take the card 200 to a voting booth, bank kiosk, or other designated location that has a computer terminal. The user may then simply press the button 210 to activate the card circuitry. In the embodiment shown in FIG. 2B, the card circuitry may be activated by authenticating the user's fingerprint via an embedded biometric sensor 224. The circuitry may then illuminate a display device 216 so as to provide a token value 222 that is generated by an internal token value generator in the card 200. The user enters the value 222 into the computer terminal and a back-end token value authenticator determines whether to authenticate the user. Once authenticated, the computer terminal may then, for example, in the case of voting, run voting software to interact with the voter and record the voter's election choices in accordance with known methods. In the case of financial transactions, the computer terminal may then run software to interact with the user and provide the user with access to financial information and transactions.

With further reference to FIG. 2B, the biometric sensor 224 may be used for authentication in conjunction with or independently of the token value generator. In this manner, a record of a user's fingerprint scan may be obtained and stored in a back-end secure identification system during a registration process. Then, for example, when a user attempts to use a voting or financial card 200, a static identifier may be entered (e.g., a PIN or card serial number) into a voting or financial terminal. Then, a fingerprint scan may be entered into the terminal, which is then received by the back-end system in order to compare with the stored record of the registered user for authentication. The fingerprint scan may be transmitted from the card to the terminal by wireless signals, such as Bluetooth™, RF, NFC, etc., via a transmitter located on the card 200 and a receiver located on the terminal.

The fingerprint scan authentication may be carried out as the sole method of authentication or it may be used in conjunction with any other method of authentication, such as the token value authentication described herein. In further embodiments, a fingerprint scan is used as the static identifier and the authentication process includes a secondary level of authentication that utilizes the token value authentication process described herein. In still further embodiments, the biometric fingerprint sensor 224 is used only to activate circuitry within the card 200 and is not transmitted to a back-end system for authentication.

The back-end authenticator may be further provided with a tallying mechanism so that, once a voter associated with a particular voting card has recorded his election choices, the authenticator is programmed to not authenticate the user in any subsequent attempts. The tallying mechanism may be programmed to allow any number of authentications, depending upon the structure of the election or elections for which the voting card 200 is used.

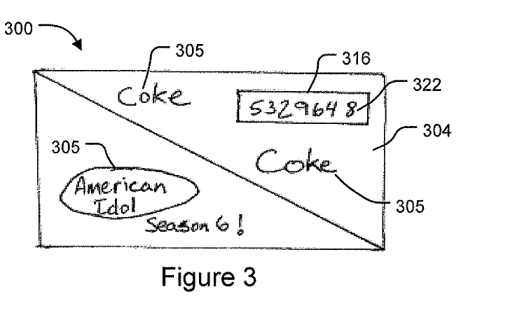

FIG. 3 is a commercial voting card 300 configured to be used to vote, for example, for contestants on a television show such as American Idol™. Similarly to the election voting card 200, the commercial voting card 300 includes a substrate 304 within which various devices are mounted (i.e., a battery, circuitry, activation mechanism, token value generator, all not shown). Printed on the substrate 304 are various graphical indicia 305 for identification and/or aesthetic purposes. The card 300 further includes a display 316 for displaying a token value 322. The display 316 may be activated upon the triggering of a switch or sensor located on the card, for example, a sound sensor, a light sensor, a motion sensor, biometric sensor, or mechanical switch.

The powered voting card of the present invention may also be provided with lights means including LEDs or electroluminescent display (ELD) technology (available from, e.g., Philips Electronics of Amsterdam; Sharp of Osaka, Japan; or Planar Systems, Inc., of Beaverton, Oreg.), and/or a speaker for sound features.

To save power, the powered card may be provided a manual switch to enable the display or sensor. In this way, the powered card shelf life can be substantially extended. The switch may also, instead, be light sensitive, pressure sensitive, or capable of being wirelessly activated.

The powered cards in accordance with the present invention may be given away free, given away as part of a related promotion, given as a gift with a purchase of an unrelated item, or made available for purchase on their own as products in their own right.

As mentioned above, it may be desirable that the user employ a PIN in conjunction with the token value to generate a one time passcode. One way to obtain such a PIN is by including the same on the powered card itself, or, perhaps, more preferably, by enabling an on-line pre-registration procedure to identify individual voters and allow voters to select their own PINs, etc. Registration adds a level of authentication (namely, that there is more certainty that the person who registered is also the person who cast a vote).

To ensure that only one vote (or some predetermined number of votes) is cast per powered card in a given amount time, once a vote is cast and received by a tallying agent, subsequent voting using the same card may be blocked for the given amount of time. Thus, in an American Idol™ scenario, the same card could be employed for voting, e.g., for a reasonable number of votes per broadcast/time period/season, etc. Consequently, there can be a high degree of confidence that the votes received have indeed been cast by different individuals (or no more than a certain number from a given individual).

The use of the powered card in accordance with the invention may be by telephone where the voter enters the token value via the dial pad. Voting may also be implemented using a computer connection, e.g., using the world wide web or Internet. The token-supplying voting powered card may also be suitable for use with mobile phone-supported applications such as the short message service (SMS). More specifically, users may input the token value in an SMS message along with a vote at the end of (or before) the token number (e.g., 1 for a yes vote, 2 for a no vote, or 1 to vote for a particular pre-designated person/topic).

Because the form factor of the present invention is similar to that of a credit card or playing card, it is more conducive to being marketed through multiple and potentially disparate distribution channels. For instance, the powered voting card may be given away for free at stores, concerts, or on the street, may be branded or co-branded, may be sent via mail order, and may be associated with clothing, food, or Internet applications, among other things. Because the card itself may be produced using well-known card manufacturing techniques, the card's graphics can be easily changed to suit the particular voting campaign, target market, or seasonal theme.

Those skilled in the art will appreciate that the powered voting card of the present invention is quite different from a single use, static ID card. For instance, with a static ID card, it is not possible to authenticate that the vote made is actually from the card itself, meaning that someone could copy the static number of the card and vote. The real “owner” of the card could then also vote, and a tallying mechanism/server would not be able to tell which vote was from the authentic user. Even if pre-registration occurred with a static ID card, or “scratch card” number, one's vote could not be authenticated or validated unless the tallying mechanism/server managed to capture, e.g., an IP address associated with a computer from which pre-registration was performed. Of course, if authentication/validation were based on a computer's IP addresses, one could not then vote from, e.g., a library or a friend's house, as the IP address (the basis for authentication/validation) would almost certainly be different from the IP address stored at the time of pre-registration.

In accordance with an embodiment of the present invention, instructions adapted to be executed by a processor to perform a method are stored on a computer-readable medium. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the context of this document, a “computer-readable medium” can be any means that can contain, store, communicate, propagate, or transport the program for use by or in connection with the instruction execution system, apparatus, or device. The computer readable medium can be, for example, but is not limited to, an electronic, magnetic, optical, biometric, electromagnetic, infrared, or semi-conductor system, apparatus, device, or propagation medium. More specific examples (a non-exhaustive list) of computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1-25. (canceled)

26. A powered card, comprising:
a substrate;
a battery disposed within the substrate;
a dynamic token value generator disposed within the substrate, the dynamic token value generator being powered by the battery;
an electronic, display mounted on the substrate for displaying a token value generated by the dynamic token value generator,
a mechanical switch, wherein closing the mechanical switch completes a circuit in the card which causes the dynamic token value generator to generate the token value which appears on the electronic display
wherein the token value is configured to be used in conjunction with a back-end token value secure identification system to provide access to previously inaccessible electronic information.

27. The powered card of claim 26, wherein the mechanical switch comprises a plurality of buttons on the substrate configured to activate a circuit in the card when a static identification code associated with an authorized user of the card is entered into the card using the plurality of buttons.

28. The powered card of claim 26, wherein the mechanical switch is a press button.

29. The powered card of claim 26, wherein the powered card is a powered financial information access card and wherein the previously inaccessible electronic information is financial information or transactions over an electronic network.

30. The powered card of claim 26, wherein:
the powered card is a powered video game playing card and wherein the previously inaccessible electronic information is a locked portion of the video game; or
wherein the powered card is a powered voting card and wherein the previously inaccessible electronic information is a secure identification system used to authenticate a voter.

31. The powered card of claim 26, wherein the powered card is a powered voting card and wherein the displayed token value is configured to be:
entered into a network terminal in order to communicate with the back-end token value secure identification system for authentication; or
entered into a polling station terminal in order to communicate with the back-end token value secure identification system for authentication.

32. A method of providing access to electronic information, comprising:
distributing a plurality of cards as set forth in claim 26;
receiving, through a network, a token value generated by a dynamic token value generator in one of the plurality of cards, the token value being inputted by a user;
authenticating the received token value by means of a back-end token value secure identification system; and
if the token value is authenticated, providing access to previously inaccessible electronic information.

33. The method of claim 32, wherein the token value is an encrypted light array, alphanumeric characters, a graphic, or an audio message.

34. The method of claim 32, wherein the electronic information is a portion of an online video game or a media file.

35. The method of claim 32, further comprising:
receiving, through the network, a password that is associated with the user;
monitoring the number of times the uses accesses electronic information, and limiting access beyond a predetermined number of times; or
associating a particular one of the plurality of cards with a particular user.

36. The method of claim 35, wherein the method further comprises associating a particular one of the plurality of cards with a particular user and wherein associating is achieved:
with a permanent card serial number;
by pre-registration with a static identification value; or
by biometric fingerprint scan.

37. A method of administering a vote, comprising:
distributing a plurality of voting cards to voters, each voting card having a thin and flexible form and having a dynamic token value generator mounted therein;
associating a static identifier with voters that receive a voting card; and
authenticating a particular voter by:
receiving an input denoting an identification of the particular voter;
receiving an input corresponding to a static identifier, wherein the particular voter is firstly authenticated by validating that the static identifier is associated with the particular voter;
receiving an input corresponding to at least one of a biometric fingerprint scan and an instantaneous token value displayed on the voting card received by the particular voter, wherein the particular voter is secondly authenticated by validating at least one of the at least one of a biometric fingerprint scan and an instantaneous token value by means of a back-end secure identification system, wherein, if the particular voter has been firstly and secondly authenticated, allowing the particular voter to proceed to cast a vote.

38. A method of administering a vote, comprising:
distributing a plurality of voting cards to voters, each voting card having a thin and flexible form and having a dynamic token value generator mounted therein;
associating a static identifier with each voting card in a back-end system, wherein each static identifier is provided and distributed along with its associated voting card; and
authenticating a particular voter card by:
receiving an input corresponding to a static identifier;
receiving an input corresponding to at least one of a biometric fingerprint scan and an instantaneous token value displayed on the particular voting card, wherein the particular voter card is authenticated by validating at least one of the at least one of a biometric fingerprint scan and an instantaneous token value by means of a back-end secure identification system based on the input corresponding to a static identifier, wherein, if the particular voter card has been authenticated, allowing the voter to proceed to cast a vote.

39. The method of claim 38, wherein the received input corresponding to at least one of a biometric fingerprint scan and an instantaneous token value corresponds to an instantaneous token value, and the instantaneous token value is inputted by a voter through:
a landline or mobile telephone;
a computer terminal; or
a mobile device by short message service.

40. The method of claim 32, wherein the card displays a token value to the user or voter upon the activation of card circuitry by at least one of a mechanical switch, a light sensor, a sound sensor, a motion sensor, a biometric sensor, and a wireless signal.

41. The powered card of claim 27, wherein the powered card is a powered financial information access card and wherein the previously inaccessible electronic information is financial information or transactions over an electronic network.

42. The powered card of claim 28, wherein the powered card is a powered financial information access card and wherein the previously inaccessible electronic information is financial information or transactions over an electronic network.

43. The method of claim 33, further comprising:
receiving, through the network, a password that is associated with the user;
monitoring the number of times the user accesses electronic information, and limiting access beyond a predetermined number of times; or
associating a particular one of the plurality of cards with a particular user.

44. The method of claim 34, further comprising:
receiving, through the network, a password that is associated with the user;
monitoring the number of times the user accesses electronic information, and limiting access beyond a predetermined number of times; or
associating a particular one of the plurality of cards with a particular user.

45. The method of claim 32, wherein the electronic information is financial information or financial transactions over an electronic network.
